(19) United States
(12) Patent Application Publication
(10) Pub. No.: US 2004/0015330 A1
(43) Pub. Date: Jan. 22, 2004

(54) System and method for testing electronic devices and modules

(76) Inventors: Majid Ghameshlu, (US); Karlheinz Krause, Planegg (DE)

Correspondence Address: Kevin R. Spivak, Morrison & Foerster LLP, Suite 300, 1650 Tysons Boulevard, McLean, VA, 22102, US

(21) Appl. No.: 10/419,881

(22) Filed: Apr. 22, 2003

(30) Foreign Application Priority Data
Apr. 23, 2002 (EP) 02009072.6

(51) Int. Cl. G21C 17/00; G06F 15/00

(52) U.S. Cl. 702/182

(57) ABSTRACT

The logical verification of electronic systems including electronic devices, modules and software during the design phase is considered an essential requirement today because of the high degree of complexity of such systems. Often, electronic devices are emulated on a verification system implemented for this purpose. The invention provides for the logical verification to be performed by means of a logic circuit operated at a first clock rate, the logic circuit emulating the device or module to be verified, and an electronic device operated at a second clock rate, a clock rate converter delaying the faster part of the test arrangement and matching the timing schemes of interfaces.

### CLAIM FOR PRIORITY

This application claims priority to European Application No. 02009072.6 which was published in the German Language on Apr. 23, 2002.

### TECHNICAL FIELD OF THE INVENTION

The invention relates to a system and method for testing electronic devices and modules, and in particular, to provide logical verification of electronic systems and devices.

### BACKGROUND OF THE INVENTION

The logical verification of electronic systems consisting of electronic devices, modules and software during the design phase is considered an essential requirement today because of the high degree of complexity of such systems.

A method frequently employed for this verification is the emulation of the electronic devices that are to be developed on a verification system implemented for this purpose. Usually, this takes the form of a so-called emulation board which replicates the target board as closely as possible. On this emulation board, the functionality of the device to be emulated are handled either by a commercially available computer-aided emulator or by a FPGA (Field Programmable Gate Array).

In both cases the maximum attainable operating clock rate of the emulation board usually lies far below the system clock rate of the target board. The operating clock rate of an emulation board is less than 1 MHz, for example. This operating clock rate determines the “system clock rate” for the emulation board, whereas the system clock rate of the target board is orders of magnitude higher, for example greater than 100 MHz. For logical or functional verification, no restriction results from the comparatively low operating clock rate, apart from the correspondingly low processing speed of the emulation boards.

However, a problem occurs when the devices to be used on the target board, particularly CPU devices (CPU: Central Processing Unit), for example, cannot be operated at an arbitrarily low frequency, for example because internal PLL units (PLL: Phase Locked Loop) prevent such a low frequency from being set, since the operating clock rate of the emulation board lies outside the specification range of the PLL units.

Known solutions to the problem provide control pins on devices with integrated PLL unit, via which the integrated PLL unit can be deactivated. A disadvantage here is that control pins of this type demand increased overhead during the design and production of the devices, because, for example, additional control pins have to be provided or separate signal patterns have to be introduced for existing control pins, by means of which the integrated PLL unit is deactivated. In addition, accidental deactivation of the integrated PLL unit in actual operation must be prevented by appropriate measures, which in turn necessitate time and effort.

A further solution includes performing the emulation using devices having no PLL unit or an integrated PLL unit which can be deactivated. This solution would be disadvantageous, however, since there is no certainty that the functionality is adequately covered and since comparable devices do not exist in many cases and would be time-consuming and costly to design and produce.

### SUMMARY OF THE INVENTION

The present invention specifies a method and a circuit arrangement for testing electronic devices and modules with integrated PLL units that cannot be deactivated.

According to one embodiment of the invention, there is a method for testing electronic devices or modules, according to which:

the device or module to be tested is emulated by a logic circuit B, the logic circuit B being operated at a first clock rate E,

a further electronic device CPU, which in actual operation is connected to the device to be tested or is part of the module to be tested, is operated at a second clock rate H,

a clock rate converter T is connected to the logic circuit B via. a first interface Bus1 operated according to the first clock rate E, the clock rate converter T is connected to the further device CPU via a second interface Bus2 clocked according to the second clock rate H, and

signals transferred by the clock rate converter T via the first interface Bus1 are matched to signals transferred via the second interface Bus2, whereby signals received by the clock rate converter T via the interfaces Bus1, Bus2 according to the clock rates E, H input into the clock rate converter T are buffered by storage elements of the clock rate converter T and provided for output to the respective other interface Bus1, Bus2, and whereby wait cycles are signaled by the clock rate converter T via that interface Bus1, Bus2 that is clocked according to the higher of the clock rates E, H.

Advantageously, as a result of using the method according to the invention and the circuit arrangement according to the invention, the use of replacement devices with a deactivatable PLL unit is not required. Thus, the functional restrictions caused by the replacement devices are avoided.

In those cases in which no replacement devices are present and the design and production of such replacement devices does not make economic sense, the testing of the target board is only made possible at all as a result of the invention.

### BRIEF DESCRIPTION OF THE DRAWINGS

The invention is explained below with reference to a drawing as an exemplary embodiment.

FIG. 1 shows an exemplary test setup for the logical verification of an electronic module.

### DETAILED DESCRIPTION OF THE INVENTION

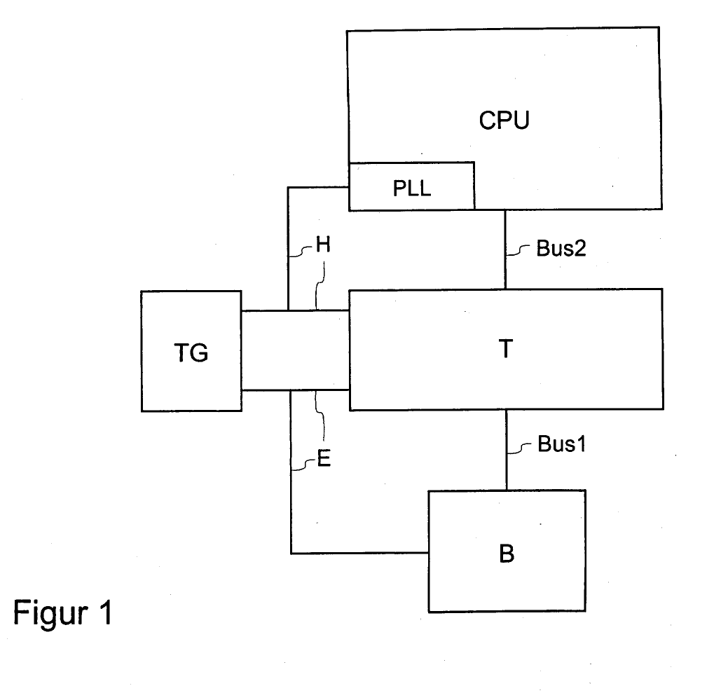

FIG. 1 shows an exemplary test setup for the logical verification of an electronic module. This module comprises a device CPU, this device CPU having an integrated phase locked loop PLL. Since a deactivatable phase locked loop PLL yields no advantages in real operation, but has disadvantages, for example in the form of additionally required signal pins or test signal patterns, this phase locked loop PLL is in many cases implemented as a non-deactivatable unit. The consequence of this is that the device CPU can only be operated at its operating clock rate H.

The functionality of the devices or module to be verified is emulated by means of a logic circuit B. However, the maximum operating clock-rate E of this logic circuit B attainable by emulation lies far below the system clock rate of the entire module in actual operation, being less than 1 MHz for example. For the verification test, this operating clock rate E of the logic circuit determines the “system clock rate” for the entire circuit during the emulation, in other words also for the device CPU.

According to still another embodiment of the invention, a clock rate converter T, also known as a bus speed converter, is provided for adjusting the different operating clock rates E, H. The clock rate converter T is connected to the logic circuit B via a first interface Bus1 and to the device CPU via a second interface Bus2. These interfaces Bus1, Bus2 are logically equivalent and differ in terms of their respective clock rates. At the same time, the clock rate of the first interface Bus1 adapts to the clock rate E of the logic circuit B and the clock rate of the second interface Bus2 adapts to the clock rate H of the device CPU. For example, the clock rate of the first interface can correspond to the clock rate E of the logic circuit B and/or the clock rate of the second interface can correspond to the clock rate H of the device CPU. Furthermore, the second interface Bus2 corresponds to the interface in actual operation between the device CPU and the remaining module.

The clock rate converter T includes storage elements which are implemented for example as FIFO (First-In/First-Out) storage elements—not shown. Moreover, both clock rates E, H are supplied to the clock rate converter. A clock generator TG is provided for generating the clock rates E, H, the way in which the two different clock rates E, H are generated being of no consequence as far as this invention is concerned.

The logical verification takes, for example, the following form: The logic circuit B to be emulated is supplied with a suitable first operating clock rate E by the clock generator TG, and the device CPU is supplied with a second operating clock rate H. A data transfer from the device CPU to the logic circuit B or vice versa is handled by the clock rate converter T, which possesses two correspondingly differently clocked interfaces Bus1, Bus2 to the device CPU and to the logic circuit B.

For purposes of the following example, it is assumed that the first clock rate E is considerably less than the clock rate H. It is further assumed, as already mentioned, that the first interface Bus1 is clocked at the clock rate E, and the second interface Bus2 at the clock rate H. It is, of course, also possible that the interfaces Bus1, Bus2 are each operated at a multiple or a fraction of the respective reference clock rate E, H. Significantly, the clock rate of the first interface Bus1 is matched to the first clock rate E and the clock rate of the second interface Bus2 is matched to the second clock rate H.

For a data transfer from the device CPU to the logic circuit B to be emulated, this data is initially transferred via the second interface Bus2 to the clock rate converter T, the data being transferred according to the timing scheme applicable to the second interface Bus2. At the same time the transferred data is valid, for example, for one clock period of the second interface Bus2. Since this clock period of the second interface Bus2 is considerably shorter—because of the considerably higher second clock rate H—than a clock period of the first interface Bus1, the data is buffered in the buffer storage elements of the clock rate generator T and output to the logic circuit B according to the timing scheme applicable to the first interface Bus1.

For a data transfer from the logic circuit B to be emulated to the device CPU, this data is initially transferred via the first interface Bus1 to the clock rate converter T, the data being transferred according to the timing scheme applicable to the first interface Bus1. The data is buffered in the buffer storage elements of the clock rate generator T and output to the device CPU according to the timing scheme applicable to the second interface Bus2. Since a clock period of the second interface Bus2 is considerably shorter than a clock period of the first interface Bus1, i.e. between two clock pulses of the first interface Bus1, many clock pulses of the second interface Bus2 are present, it must be ensured that the data on the second interface Bus2 is not requested by the device CPU before it is provided by the logic circuit B via the first interface Bus1.

In both cases, in order to match the processing speed of the device CPU, which is directly related to the second clock rate H, to the slower first clock rate E, wait cycles are signaled to the device CPU by the clock rate converter T by means of suitable commands or signals, for example in the form of WAIT signals or NOP commands (NOP: No Operation). To put it another way, the clock rate converter T ensures that the device B operated at the higher second clock rate H is harmonized with the timing scheme of the lower first clock rate E.

The present invention is not limited to the exemplary embodiment. For example, the method according to the invention can also be applied in other situations in which a clock rate adjustment is necessary.

Such a situation would be the use of a fast-running component, for example a CPU, in an otherwise slow-running circuit, motivated, for example, by the fact that relatively highly clocked CPU devices are available at reasonable cost and in large volumes, whereas slow CPU devices are increasingly being produced in smaller volumes and consequently at higher cost.

What is claimed is:

1. A method for testing electronic devices or modules, comprising:
emulating a device or module to be tested by a logic circuit, the logic circuit operated at a first clock rate;
operating an electronic device, which is configured for connection to the device to be tested or is part of the module to be tested, at a second clock rate;
connecting a clock rate converter to the logic circuit via a first interface operated according to the first clock rate;
connecting the clock rate converter to the electronic device via a second interface operated according to the second clock rate; and
matching signals transferred by the clock rate converter via the first interface to signals transferred via the second interface, wherein signals received by the clock rate converter via the interfaces according to the clock rates input into the clock rate converter are buffered by storage elements of the clock rate converter and provided for output to the respective other interface, and wherein wait cycles are signaled by the clock rate converter via the interface that is clocked according to the higher of the clock rates.

2. The method according to claim 1, wherein the second clock rate is selected as equal to an operating clock rate of an internal phase locked loop of the electronic device, the second clock rate being substantially higher than the first clock rate.

3. The method according to claim 1, wherein the wait cycles are signaled by the clock rate converter to the device by means of WAIT signals transferred via separate signal lines of the electronic device or by means of NOP commands.

4. The method according to claim 1, wherein the logic circuit is implemented at least in part by a computer-aided simulation or a programmable logic array.

5. A circuit arrangement for testing electronic devices or modules, comprising:
a logic circuit to emulate the device or module to be tested, the logic circuit operated at a first clock rate;
an electronic device which is configured for connection to the device to be tested or is part of the module to be tested, the electronic device operated at a second clock rate; and
a clock rate converter which is connected to the logic circuit via a first interface operated according to the first clock rate and is connected to the electronic device via a second interface operated according to the second clock rate,
wherein the clock rate converter matches signals transferred via the first interface to signals transferred via the second interface, in that storage elements of the clock rate converter buffer signals received via the interfaces according to the clock rates input into the clock rate converter and provide the signals for output to the respective other interface, and in that the clock rate converter signals wait cycles via that interface that is clocked according to the higher of the clock rates.

6. The circuit arrangement according to claim 5, wherein the electronic device has an internal phase locked loop which determines the second clock rate, the second clock rate being substantially higher than the first clock rate.

7. The circuit arrangement according to claim 5, wherein the clock rate converter has first-in/first-out storage elements and is implemented as a field-programmable gate array.

8. The circuit arrangement according to claim 5, wherein the clock rate converter signals the wait cycles to the device by means of WAIT signals transferred over separate signal lines of the electronic device or by means of NOP commands.

9. The circuit arrangement according to claim 5, wherein the logic circuit is at least in part a computer-aided simulation.
